(19) United States
(12) Patent Application Publication
(10) Pub. No.: US 2014/0297545 A1
(43) Pub. Date: Oct. 2, 2014

(54) System and Method for Verifying and Communicating about OEM Products

(71) Applicants: Chachi Prasad, Los Angeles, CA (US); Krishnadas Trikkovil Pisharam, Trivandrum (IN)

(72) Inventors: Chachi Prasad, Los Angeles, CA (US); Krishnadas Trikkovil Pisharam, Trivandrum (IN)

(21) Appl. No.: 14/025,767

(22) Filed: Sep. 12, 2013

Related U.S. Application Data
(60) Provisional application No. 61/700,063, filed on Sep. 12, 2012.
(60) Provisional application No. 61/826,491, filed on May 23, 2013.

(51) Int. Cl. G06Q 30/00

(52) U.S. Cl. CPC G06Q 30/0185
USPC 705/318

(57) ABSTRACT

The present invention is directed to a mobile software application developed for a smart phone or mobile device, such as an iPhone, iPad, Android, or Blackberry personal digital assistant, equipped with a camera, image sensor, RFID detector, or NFC sensor, that enables a user to synchronize information to verify the present status of whether an OEM product is genuine, subject to recall or stolen, and further allows the user to communicate and share information about his or her experience with the product using social media and networking sites on the Internet.

### BACKGROUND OF THE INVENTION

1. Field of the Invention

The invention relates generally to the field of mobile applications for handheld devices, and systems and methods for verifying and communicating about OEM products using social media and networking websites on the Internet.

2. Background Information

Original equipment manufacturers (OEM) manufacture products or components of products, which they sell to authorized dealers and/or retailers who then sell the products to end consumers under the OEM's brand. Some OEMs also sell their goods and products directly to end consumers in the market. The OEM's brand, which includes trademarks, service marks, logos, trade names, and tag lines, is a valuable intangible asset that indicates the OEM as the source of particular goods or services. Indeed, companies invest significant time and money in developing, marketing and protecting their brands.

Despite OEM manufacturers' efforts to protect their brands, counterfeiting is a prevalent problem. This is true especially in the area of consumer goods and luxury items, including among other things, clothing, shoes, luggage, handbags, perfumes, electronic equipment, watches, jewelry, toys, art, DVDs, and computer software. Imitation, black and grey market goods, or “knockoffs” are often manufactured, distributed, and sold in direct competition with genuine OEM products.

Often, customers have difficulty distinguishing the imitation or “knockoff” products from the genuine/authentic OEM products. Companies lose billions of dollars a year because of counterfeiting when consumers are diverted to purchasing “knockoffs” instead of genuine goods. Furthermore, the brands and goodwill associated with branded products suffer when consumers believe they are purchasing a high-quality genuine item, but receive an inferior-quality “knockoff” product.

Hence, there is a need in the marketplace for sophisticated and user-friendly technology that allows detection of counterfeit and “knockoff” products, and further allows one to alert the OEM manufacturer, as well as other consumers about whether one has purchased a genuine good or an imitation or “knockoff.” In recent years, various methods and systems have been developed to detect and track counterfeit goods.

For example, U.S. Pat. No. 5,895,073, entitled “Anti-counterfeiting System”, describes one such anti-counterfeiting system that marks, identifies, and tracks goods using a control computer, a host computer, a marking system, and field reader system that can be linked via data transmission links. The goods are marked with encoding symbols, which can be subsequently inspected with a field reader to determine whether they are genuine. U.S. Pat. No. 6,226,619, entitled Method and System for Preventing Counterfeiting of High Price Wholesale and Retail Items, discloses a method and system for preventing counterfeiting by using an interrogatable, which includes indicia visible by the purchaser for comparison with a secret, non-duplicable number or other information stored in the tag which designates authenticity.

U.S. Pat. No. 7,222,791, entitled “Counterfeit Detection Method”, describes a method including the steps of electronically reading a label on a particular item in a store, transmitting an item identification code (such as a bar code) encoded in the read label to an authentication unit, receiving an indication from the authentication unit as to whether the identification code is registered to the store, and if the indication is positive, generating a certificate of authenticity for the item. U.S. Patent Application Serial No. 20040172537, entitled “System and Method for Tracking and Authenticating Items Through an Internet Web Site”, describes a method for tracking an item using an internet web site for a user to verify that the item is genuine, which includes the steps of entering a code to obtain secure access to the web site, selecting the item from a list on the website, determining whether the code is authentic, allowing modification of the tracking data if the code is determined to be authentic, and sending an alert to a fraud potential if the code is determined to be not authentic. The system uses a taggant such as a TechMark™ magnetic threat or fluorescent taggant along with a second unique identifier such as a serial number or a bar code or various other identifiers.

U.S. Patent Application Serial No. 2011021172, entitled “Authentication of ‘Source’ for brands,” describes a brand source authentication system in real time. The system detects brand sources using camera-enabled imagers and hard wiring, as well as camera-enabled smart phones and internet communications, wherein the detection devices are equipped to read encoded 2-D, Data Matrix type symbology included in the products.

A synchronization system for counterfeit or stolen merchandise that is capable of use by an individual consumer to identify prospective purchases in detail in a synchronistic way which enables a user to scan a product for a unique identifier with a personal mobile device such as a cell-phone and synchronize communications with OEM's regarding the status and/or validity of the item has not been previously identified.

### SUMMARY OF THE INVENTION

While the conventional counterfeit and fraudulent product detection systems and methods described above enable a consumer to detect if a particular good or service is genuine, they do not allow easy, user-friendly communication and dissemination of information about the genuine or imitation article to interested parties, such as manufacturers, existing and potential consumers, and product critics. Nor do they allow the consumer to share his or her experiences about the particular good or service with other interested parties that may use the information to make purchasing, marketing, and use decisions. Accordingly, the present invention is directed to a user-friendly system and method for verifying the genuineness of consumer goods and for communicating about said goods on social media and networking websites on the Internet using a hand-held smart phone or other mobile device, equipped with application software (such as an embodied synchronization APP an example of which is a Synca™ APP), hard wiring, and Imaging and/or sensing capabilities, which substantially obviate one or more problems due to limitations and disadvantages of the related art.

An object of an embodiment the present disclosure is to enable the consumer to easily detect and verify genuine OEM products and to communicate and share his or her experiences about such products on the manufacturer's social media web pages such as Facebook, Twitter, YouTube, blogs, Tumblr, the manufacturer's official website, as well as shopping carts and review pages on the manufacturer's or other authorized retailer's websites on the Internet. Another object of an embodiment of this invention is to enable consumers to detect and verify genuine OEM products and to communicate, share, or disseminate information and images about such products using a smart phone or mobile device, such as an iPhone, Android, iPad or other tablet computer, Blackberry or other personal digital assistant, that is equipped with imaging or sensing capabilities. The imaging and sensing capabilities contemplated allow the device to image, sense, detect, read, and/or decode unique indicia, symbology, or codes, such as barcodes, matrix barcodes or QR codes, radio-frequency identification (RFID) chips or tags, and/or near field communication (NFC) tags that are linked to the genuine OEM products. Yet another objective of an embodiment of the present invention is to provide a mobile application synchronization software (an example of which is the Synca™ APP) developed for a mobile device or smart phone that enables detection and verification of genuine OEM products, and further allows communication about such products using the manufacturer's social networking websites, official manufacturer websites, as well as shopping carts, and review web pages on the manufacturer's or other authorized retailer's websites on the Internet.

An embodiment of the present invention allows consumers to share their experiences about a recent purchase of an OEM product, wherein the consumer scans the unique indicia, symbology, or code, such as a barcode or matrix barcode using the embodied mobile synchronization APP on his or her mobile device or smart phone, thereby uploading the image of the product available in the manufacturer's database onto the manufacturer's social networking website, where the consumer can also post comments about the product. Another embodiment of the invention allows images of the product available in the manufacturer's database to be uploaded onto the consumer's social networking website, such as Facebook, where the consumer can then post comments about his or her experience with the product.

Another embodiment of the invention enables the consumer to use an embodied mobile synchronization APP in conjunction with an image sensor, camera, or videotaping-capability of his or her mobile device or smart phone so as to upload his or her own images and videos of the product onto the manufacturer's social media and networking websites, or the manufacturer's official website. In a further embodiment of the invention, the consumer can use a mobile synchronization application in conjunction with programs such as Instagram, YouTube, Flickr, Facebook, and Twitter to share images, videos, and other information about his or her experience with the OEM product. The consumer can scan or detect indicia, barcodes, matrix barcodes, RFID tags, or NFC tags on a particular OEM product using an embodied mobile synchronization application and post images of the OEM product and comments about the product automatically on the manufacturer's social media and networking pages, such as Facebook, Twitter, or the manufacturer's website. Additionally the user may compare the scanned product with reviews and pricing for competitive product alternatives.

Another embodiment of the invention enables consumers to send instant text messages in real time to the manufacturer or other third parties using an embodied mobile synchronization application to alert that a particular OEM product is a counterfeit or knockoff product. In another embodiment of the invention, the mobile application enables the user to register the OEM product he or she has purchased with the manufacturer if he or she so chooses. The registration information for the product can be changed if the product is sold or donated to another consumer. Further, once a consumer uses an embodied mobile synchronization application to scan and register an OEM product with the manufacturer using either the manufacturer's social media pages, networking websites, or official website, the manufacturer may directly communicate with the consumer to provide general information about the product, product defect or recall information, as well as promotional discounts and coupons for the same or related products. The manufacturers or consumers may provide data regarding retail term compliance. The manufacturer may even provide a quick survey at the end asking the consumer why they chose X product over Y. Or the consumer may volunteer the same information onto social media or to the OEM itself. The OEM may provide incentive programs for consumer feedback.

In another embodiment of the invention, a consumer's use of the mobile application to scan or detect the indicia, bar codes, matrix barcodes, RFID tags, or NFC tags to verify the OEM product's genuineness allows the manufacturer to determine the location where that product was scanned, thus allowing the manufacturer to generate information and prepare reports regarding product inventory, sales, consumer demographics, and other relevant marketing and product information.

Although the embodiments focus on the authenticity of the products, additional embodiments pertain to the present status of the scanned item. A scanned item may be identified as authentic/genuine additional information about whether the item is subject to recall is also available. Additional embodiments allow for the detection of stolen merchandise and a system of either alerts to the OEM, law enforcement or individual using an embodied synchronization APP.

In yet another embodiment of the invention, the mobile application launches a virtual world where consumers can communicate and interact with each other, sharing information and experiences about the OEM product.

To achieve these and other advantages and in accordance with the purpose of the present invention, as embodied and broadly described, an embodiment of the present invention provides a method for verifying whether an item is a genuine OEM product and communicating about said product on social networking websites comprising the steps of scanning unique indicia or symbology, such as a bar code, a matrix bar code, an RFID tag, or an NFC tag linked to a particular OEM item; transmitting information about said scanned code, tag, or chip to a computer database or an internet web site to verify that the code or tag corresponds to a genuine OEM product; receiving information from said computer database or internet web site regarding whether the item is a genuine OEM product; and uploading images and information, and posting comments about the product on the manufacturer's social media and networking websites such as Facebook, Twitter, YouTube, Tumblr, blogs, as well as on the manufacturer's and authorized retailers' websites and shopping carts on the internet. In another aspect of the present invention, the user can also send instant messages regarding the product to the OEM manufacturer, and other interested parties, such as other existing and potential consumers. As such, the user can alert the OEM manufacturer and third parties that a particular item is counterfeit, and also communicate about his or her experience with the product.

Another aspect of this invention describes a system for verifying the genuineness of OEM products and communicating about said products on social networking websites using a mobile application program developed for a smart phone or mobile device equipped with imaging or sensing capabilities that can image, sense, scan, detect and/or decode unique indicia and codes and tags, such as bar codes, matrix bar codes, Quick Response (QR) codes, RFID tags, and NFC tags, which are linked to OEM products.

Additional features and advantages of the invention will be set forth in the descriptions that follow and in part will be apparent from the description, or may be learned by practice of the invention. The objectives and other advantages of the invention will be realized and attained by the structure and method particularly pointed out in the written description and claims thereof as well as the appended drawings.

### BRIEF DESCRIPTION OF THE DRAWINGS

The principles of the present invention will be apparent with reference to the following drawings, in which like reference numerals denote like components:

FIG. 1 is a schematic of the method of verifying whether an item is a genuine OEM product and communicating on social media sites using an embodied synchronization application such as the Synca™ APP on a mobile device.

FIG. 2 depicts a flow chart of the steps in the method via which the manufacturer module of the Synca™ APP mobile application scans, records, and stores information for specific indicia and symbology linked to genuine OEM products.

FIG. 3 is a flow chart of the steps in the method via which the Synca™ APP determines that an item is a counterfeit or imitation product and allows the consumer to communicate about the product using social media and networking web sites and to receive product-related communications from the manufacturer.

FIG. 4 is a flow chart of the steps in the method via which the Synca™ APP determines that an item is Genuine and allows the consumer to communicate about the product using social media and networking web sites and to receive product-related communications from the manufacturer such as Offers/Coupons/Other Products and related offers.

FIG. 5 depicts the sequence of screens that appear on an iPhone, Android, Blackberry, or other smart phone following verification of the genuineness of an OEM product using the Synca™ APP.

FIG. 6 depicts a functional diagram demonstrating embodied information flow between main entities and their activities.

FIG. 7 depicts exemplary graphing of embodied analytic reports via Sales and Scanning Analytics based on male/Female/Age using the Synca™ APP on a mobile device.

FIG. 8 is a schematic of the method of communicating and retrieving lost articles using the Synca™ APP on a mobile device.

FIG. 9 is a flow chart of the steps in the method via which the Synca™ APP assists Law Enforcement/Manufacturer/Owner/Finder when a product identified is stolen or missing.

### DETAILED DESCRIPTION OF THE INVENTION

An embodiment of the present invention enables verification of the genuineness of an OEM product through comparing unique identifying indicia, symbology, and codes, such as barcodes, matrix bar codes, RFID tags, and NFC tags physically linked to the OEM product against a database containing the same. Based on a system according to an embodiment of this invention, unique identifying indicia, symbology or code are physically linked to the OEM products by the product manufacturer, authorized supplier, distributor, or administrator, and said indicia, symbols, and codes, including barcodes, Universal Product Codes (UPC), UPL, QR codes, RFID tags and NFC tags are scanned or synchronized or communicated via other technology and maintained in a database by the OEM manufacturer of administrator. Each barcode, matrix bar code, UPC, QR code, RFID tag, or NFC tag is set up to signify a specific product or stock-keeping unit (SKU) number. In other words, no two items would have the same digits per on the barcode, matrix bar code, UPC, QR code, RFID tag, or NFC tag. This would be the case even if two items have similar styles, colors, sizes, or compositions.

An embodiment of this invention provides a mobile application software (the Synca™ APP) developed for a mobile device or smart phone that enables detection and verification of genuine OEM products, and further allows communication about such products on the manufacturer's social networking websites, SYNCA's platform or site, the end consumers social pages, official manufacturer websites, as well as shopping carts, and review web pages on the manufacturer's or other authorized retailer's websites on the Internet. The Synca™ APP can be procured from mobile APP stores or purchased and downloaded from the Internet. It can be installed in a mobile device or smart phone, such as an iPhone, an Android, a Blackberry or other personal digital assistant, and/or an iPad or other tablet computer, which has a mobile camera or other sensor that can image, scan, sense, detect, and/or read indicia, symbology, and/or codes, such as barcodes, matrix barcodes, RFID tags, or NFC tags.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

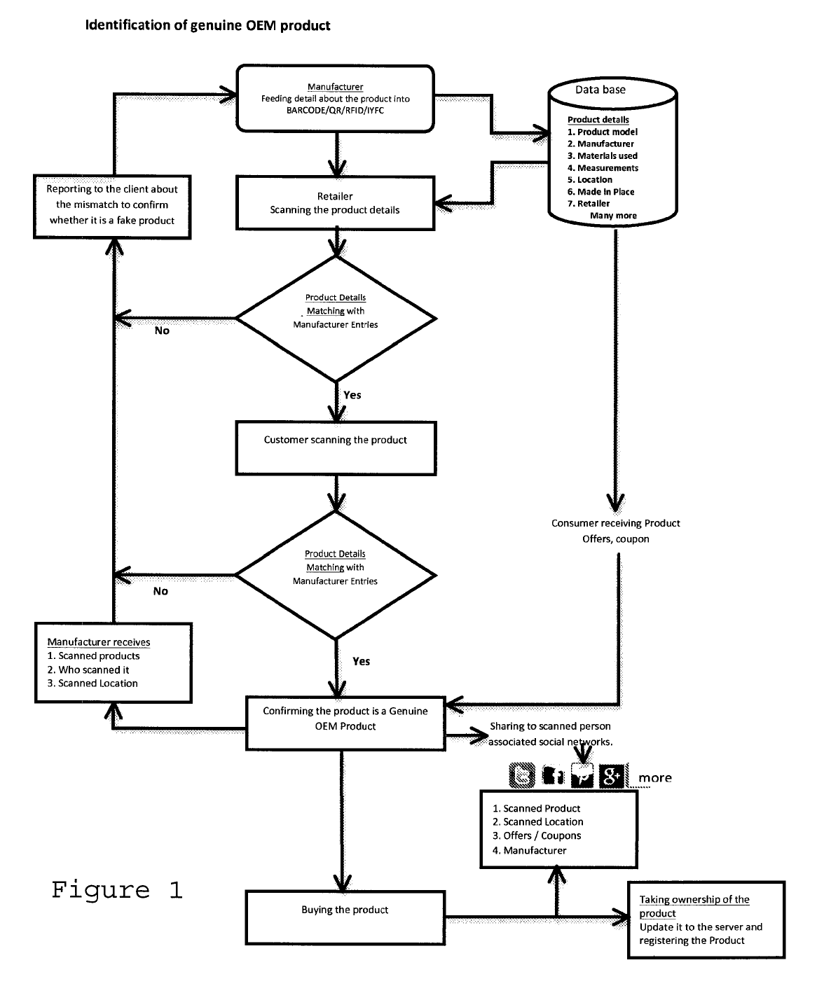

FIG. 1 illustrates the steps in a method of verifying whether an item is a genuine OEM product using the Synca™ APP installed in a mobile device or smart phone as provided by an embodiment of the present invention. As illustrated in the figure, according to a method of an embodiment of this invention, the Synca™ APP installed in an iPhone, Android, or Blackberry phone is opened, and the camera, or imager is pointed at the indicia, symbology, or code, such as a barcode, matrix barcode, or NFC tag linked to the product. If the product contains an RFID tag, it can be scanned using the hardwiring in the smart phone or mobile device. Once the indicia, symbology, or code is detected, it is communicated to the OEM manufacturer's computer database, SYNCA's database or any another Internet web-based database, which is searched for a match for the detected indicia, symbology, or code. If there is a match with the codes and symbology in the database maintained by the OEM manufacturer or administrator, the product is deemed as a genuine OEM product. If there is no match, then, the product is deemed to be an imitation or a knockoff.

The results of the search are displayed on the screen of the smart phone or mobile device, which then, opens up the link to social networking web sites, where the user can post comments about whether the item is a genuine OEM product or an imitation. The social media link or connection automatically connects to the OEM manufacturer's social media pages, including among others, Facebook, Twitter, Tumblr, Google+, YouTube, blogs, web sites, and shopping carts and review pages, where the user can post comments about the verification of the item, and indicate that he or she likes the company. The user can follow the company through the link, which also allows the user to shop and make additional purchases on the OEM manufacturer's web sites and shopping carts. The link further allows the user to upload images or pictures of the scanned item from the mobile device or smart phone, such as iPhone, Android, or Blackberry phone, and to indicate where the item was purchased, what season's item is shown in the photo, and the retail price paid by the user. Using functionalities in the APP and the OEM manufacturer's social media sites, the user can directly connect, network, and communicate with other customers who have posted comments and photos regarding their own verification, purchase, or other details about or experiences with the OEM product. The user can further register the product using tools in the Synca™ APP and the OEM manufacturer's web site. If the user sells or donates the product to another consumer, the user can remove or transfer the registration information using the Synca™ APP, and the second owner of the product can then, register the product at the OEM manufacturer's web site, so that the appropriate party can be contacted in the event of a product recall, product lost or stolen, product warranty, brand event, or other event.

According to an embodiment of the present invention, the mobile application program (the Synca™ APP) has at least two modules, including a manufacturer or administrator application, and a customer application. With respect to the manufacturer or administrator module, the OEM manufacturer or administrator can access the mobile application (the Synca™ APP) by entering a user name and password to login to the system on a personal computer, smart phone, or personal digital assistant. If the login details are correct, the OEM manufacturer or administrator successfully logs in. If not, a pop up window with the message “Username or Password incorrect” appears and stays on the screen of the mobile device, smart phone, personal digital assistant or personal computer.

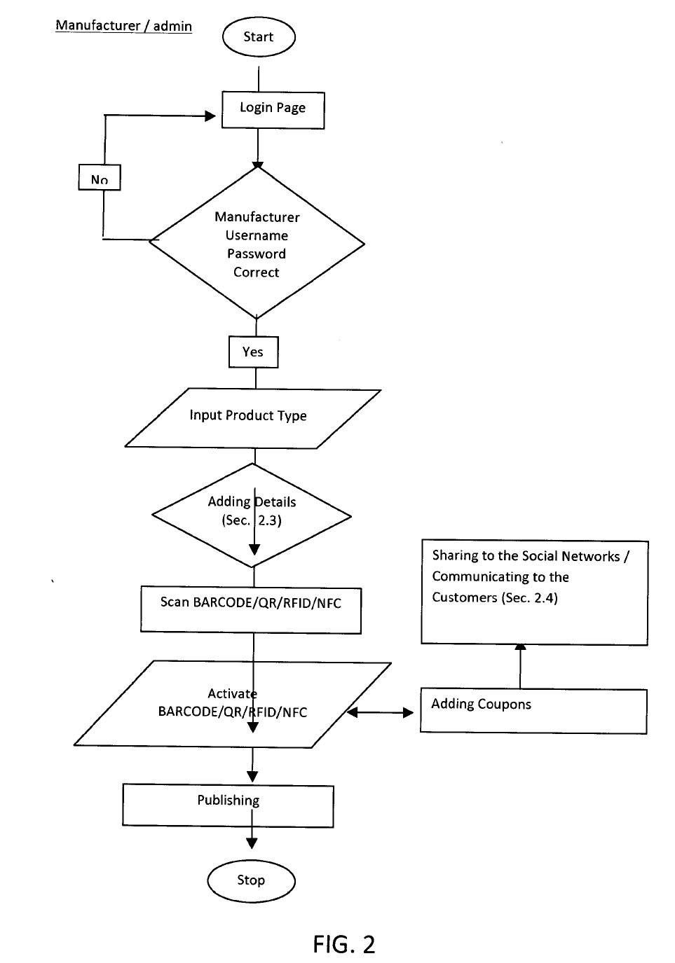

Following successful login, the OEM manufacturer or administrator chooses a specific item by accessing a drop down list of OEM products on the screen. He or she scans, reads, or senses the indicia, symbology, or codes, such as bar codes, matrix bar codes, RFID tags, and NFC tags on the item using either the mobile device equipped with an imager or sensor, or by using a separate imaging or sensing tool or device, such as a bar code scanner, RFID reader, or NFC sensor. If the indicia, symbology, or codes have been properly scanned, they are added to the OEM manufacturer's database, with details. The database may be stored on the personal computer and maintained in the OEM manufacturer or administrator's server, or on a cloud computing platform. The administrator also has the option to run analytics from this area on his or her mobile device based on multiple criteria of choosing. If errors are made in the process of entering item details to the database, they will be indicated on the screen. For example, if a product type is not selected from the drop down list, then a pop-up window will appear on the screen with the error message “Choose Product First.” Once the indicia, symbology, or code has been added to the database, the OEM manufacturer or administrator can log out of the application using the Logout button. FIG. 2 illustrates a flow chart of the steps via which the OEM manufacturer or administrator scans and enters product information and indicia, symbology, or codes in the OEM manufacturer database.

Using the mobile application, the Synca™ APP, installed in an iPhone, Android, iPad, Blackberry, or other smart phone, an administrator or authorized retailer can ensure that the products he or she is selling are genuine. For example, if a manager at a store that sells branded OEM products wanted to verify the genuineness of a particular product, he or she would log into the Synca™ APP on his smart phone, Android, or Blackberry using his or her username and password combination. Once the manager/administrator is logged in, he or she can scan a barcode, or QR code using the image sensor or camera in his or her iPhone, Android, Blackberry, or other smart phone device, equipped with the Synca™ APP. Clicking the scan button starts the camera or image sensor, and simply pointing the image sensor on the barcode or QR allows the Synca™ program to detect the barcode, QR code, or other symbology.

In smart phones and mobile devices that are equipped with RFID chips, the RFID detector is activated when the manager/administrator logs into the application using his or her username and password combination. The administrator can then enter the details regarding the RFID tags on a particular product that are automatically read and detected by the RFID detector in the iPhone, Android, Blackberry, or other smart phone.

Similarly, smart phones equipped with NFC, RFID sensors can read and detect NFC,

RFID tags on products. Once an OEM product is properly scanned, the verification of genuineness data is entered by the administrator into the manufacturer's or administrator's database along with other necessary product details.

According to an embodiment of the present disclosure, consumers can verify if an OEM product they are purchasing is genuine by using the customer module of the Synca™ APP installed in their iPhone, iPad, Android, Blackberry, or other smart phone. Using the camera, image sensor, RFID detector, or NFC sensor, or other communication or synchronization technology on the smart phone or mobile device, equipped with the Synca™ application, the customer can scan the bar code, QR code, RFID tag, or NFC tag on the product. The Synca™ APP compares the indicia, symbology, codes, or numbers against those in the manufacturer's database to find a match. Once the indicia, symbology, codes, or numbers have been compared, a message will appear on the iPhone, iPad, Android, Blackberry or other smart phone indicating if the product is genuine or not. If a product is a genuine OEM product, the message will read ORIGINAL, or GENUINE Product. If the Synca™ APP finds no match for the indicia, symbology, code, or numbers in the manufacturer's database, the message will read IMITATION or COUNTERFEIT Product.

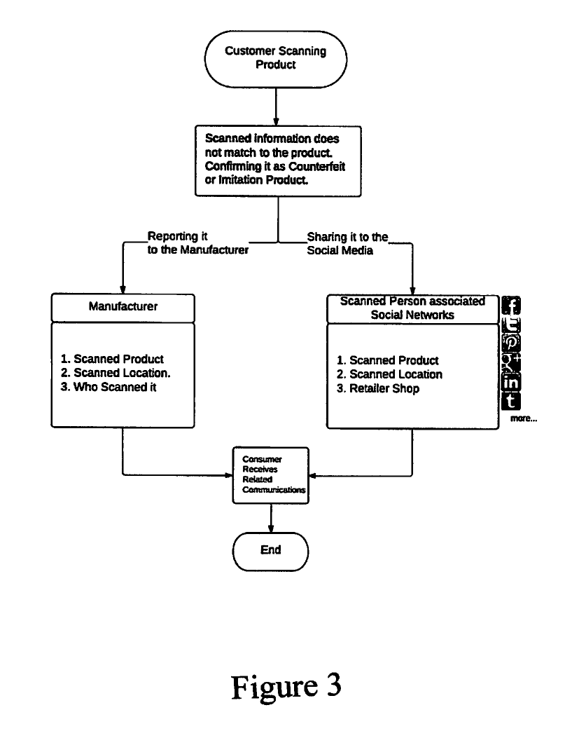

FIG. 3 illustrates a flow chart of the steps via which a consumer verifies the genuineness of a product and then, communicates with others on the manufacturer's social media websites, their own social media pages, and on SYNCA's virtual world or social page, on the Internet using the Synca™ APP. As shown in FIG. 3, the consumer can directly communicate with the manufacturer or the administrator by sending instant messages, and email with questions or comments, to which the manufacturer can respond in real time, thereby enhancing the consumer's shopping experience. As such, the mobile application (the Synca™ APP) builds a customized virtual world for manufacturer's and consumers to interact with each other. The flow chart in FIG. 3 also shows that the consumer can upload images of the product to various social media sites, where he or she can post comments and communicate with third or other parties about the product. As shown, the consumer can also access coupons and information about related products using a Synca application. The consumer may also have the ability to link to other consumers who have bought similar products or have similar buying habits. This is all done on the back end by SYNCA's software. For example, if a customer has a question regarding a particular watch, they can be linked to other customers who have also purchased similar items to make their experience more informed in terms of getting advice and or solutions to problems with the particular product.

After purchasing an OEM product which the consumer has verified as a genuine product, the consumer can register the product using functionalities of the mobile application (the Synca™ APP) on his iPhone, iPad, Android, Blackberry or other smart phone. The consumer can enter details about the product in the registration form on the Synca™ APP, specifying the owner's name company, address, contact phone number, contact email address, serial number of the product, the store and location where the product was purchased, and whether the product is used or new, also the may upload receipts, images or invoice and or Warranty papers. The data of the purchase will be automatically generated by the Synca™ APP when the indicia, symbology, barcode, or QR code on the product is scanned with a smart phone camera or other image sensor, RFID detector, NFC sensor or other communication or synchronization technology.

Using an embodiment of the mobile application (the Synca™ APP), the manufacturer or administrator can generate and prepare reports regarding product and consumer base data, such as location, date of purchase, names of shops and businesses where a particular product is sold, whether any of them have been identified as selling an IMITATION or COUNTERFEIT product, as well as customer information to determine the demographics of existing and potential customers, thereby collecting relevant information for marketing and advertising purposes. For example, the manufacturer or administrator can generate graphs showing (1) product sales and dates of purchase; (2) product sales and location; (3) product sales in a particular location and the date of purchase; (4) product sales at a particular store or authorized retail establishment and the date of purchase; and (5) product sales in a particular store or authorized retail establishment and the specific type of OEM product. The manufacturers can gather data regarding retail term compliance. Additionally, the manufacturer may even provide a quick survey at the end asking the consumer why they chose X product over Y.

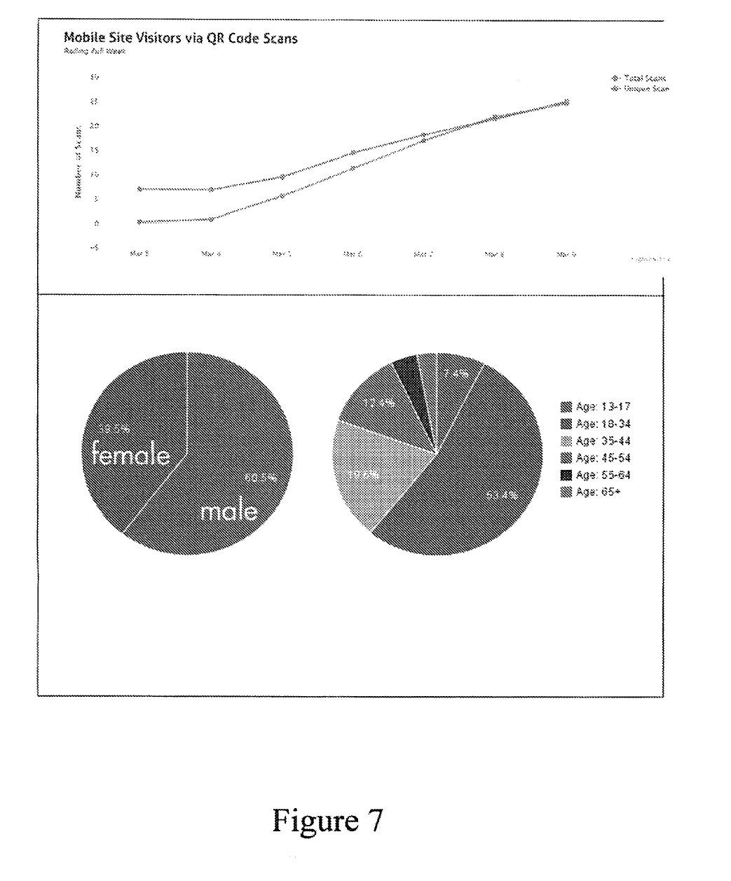

Another embodiment of the disclosure relates to the data analytic capabilities of quantitatively and qualitatively aggregating the data related to purchases, people demographics, buying habits, manufacturer's success related to pricing advertising, promotions and coupons and a variety of other general consumer and individual member based purchasing habits and decision making factors. The embodied synchronization application can determine buying and spending habits, preferences, size and shape of consumers and aggregate data from every scan. The data collected from each scan can be aggregated via proprietary software and the qualitative and/or quantitative data can be provided to manufacturers retailers, wholesalers, or distributors for better organizing their business and reacting quicker to the market and for synchronizing and streamlining all facets of the business. An example of a report that may be provided is shown in FIG. 7.

After the customer module of the mobile application according to an embodiment of this invention (the Synca™ APP) has been installed in a smart phone or device, such as an iPhone, iPad, Android, or Blackberry personal digital assistant, and the consumer has used the application once to verify an OEM product, he or she does not have repeatedly enter in the username and password combination each time he or she operates the application. Rather, if the consumer opens the mobile application (the Synca™ APP) on his or her smart phone, Android, or Blackberry, and chooses the SCAN option in the application, the camera, image sensor, RFID detector, or NFC sensor on the phone, or other communication and sunchronization technology automatically switches on, and scans, reads, or otherwise detects indicia, symbology, barcodes, QR codes, RFID tags, or NFC tags associated with particular OEM products. The indicia, symbology, barcodes, QR codes, RFID tags, and NFC tags are compared against the information in the manufacturer's database using functionalities of the Synca™ application. If there is a match, a message appears on the consumer's iPhone, iPad, Android, Blackberry, or other smart phone, stating that the product is ORIGINAL or GENUINE Product. And, if there is no match, the mobile application program (the Synca™ APP) generates a message, stating that the product is an IMITATION or COUNTERFEIT Product.

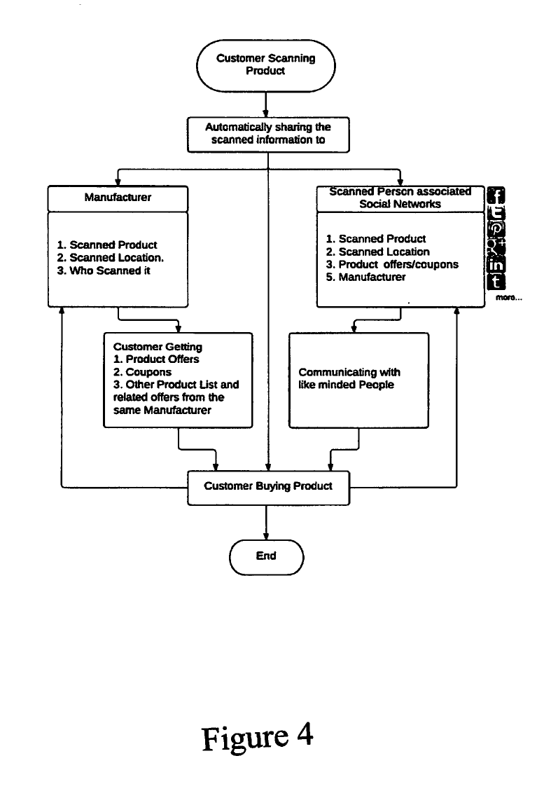

Consumers can also use the mobile application program (the Synca™ application) to retrieve other details about the product, which are stored in the database, such as product specifications, category, season of launch, and the link to the manufacturer's, administrator's, SYNCA's or another companies, or the user's own social media or networking page, including Facebook, Twitter, Tumblr, Google+, blogs, official manufacturer website, and online shopping carts. With respect to the link to the manufacturer's Facebook page, the Synca™ APP would ask consumers with existing Facebook accounts to log into the site using their username and password information, and would ask those without Facebook accounts to sign up for a new account on Facebook. If the consumer has forgotten his or her Facebook password, functionalities on the mobile application (the Synca™ APP) linking to Facebook would allow the consumer to retrieve his or her password information. Once the consumer is at the manufacturer's Facebook site, he can enter comments about his or her experience with the OEM product, attach an image of the product from the manufacturer's library, or upload his or her own images and videos of the product, and then, select the button, PUBLISH STREAM. If successful, the message POSTED SUCCESSFULLY IN FACEBOOK appears on the consumer's iPhone, iPad, Android, Blackberry or other smart phone or device. FIG. 4 depicts the sequence of screens with prompts allowing the consumer to log into the manufacturer's Facebook page to post comments and share his or her experiences with the OEM product. The synchronized applications of the present disclosure also have the ability to link customers who have purchased similar products thus enhancing the social and consumer experience.

Using the mobile application according to an embodiment of this invention (the Synca™ APP), the consumer can also post comments, upload images of the product taken with the camera or imager or his or her iPhone, ipad, Android, Blackberry, or other smart phone or device, on his or her own Facebook page. The consumer can interact with other consumers who have posted comments about the OEM product using the functionalities available on Facebook, or other social networking site. The consumer may also post comments about products that were determined to be IMITATION Products by his or her Synca™ APP, thus alerting the manufacturer, and other existing and potential customers about knockoff and counterfeit products. Consumers may also post comments about where they purchased ORIGINAL Products, thereby, informing others about where such products are sold.

The mobile application according to an embodiment of this invention (the Synca™ APP) can also be used to post messages to other social media and networking sites, such as Twitter, Tumblr, and the manufacturer's and consumer's blogs. For example, with respect to a link to Twitter, the mobile application (the Synca™ APP) would request the consumer to enter username and password information if he or she is an existing user of Twitter. If the consumer is not an existing user of Twitter, he or she would be asked to create a new account in order to post tweets. As with Facebook, and other social media and networking pages, the consumer can retrieve a password if he or she has forgotten it. Once the consumer is logged in, he or she may type comments and select the button, PUBLISH. If successful, the message SUCCESSFULLY POSTED ON TWITTER is shown on the smart phone or device. The consumer can also see comments posted by other users about the OEM product. The consumer can follow the sequence of screens with prompts for entering log in information and comments on the manufacturer's Twitter website.

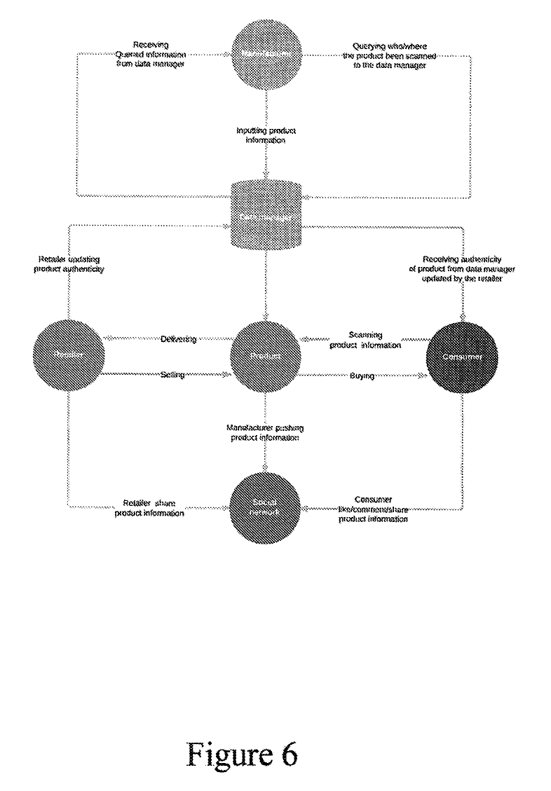

As described in the examples above, which are purely for illustration, and not limiting, the mobile application according to an embodiment of this invention (the Synca™ APP) enables consumers to communicate and exchange information about OEM products using social media and the Internet, while allowing manufacturer's a direct and immediate, reach to their existing and potential customer base. By using the mobile application according to an embodiment of this invention, (the Synca™ APP), manufacturers can quickly respond to the problem of counterfeiting, and further alert their customers of special events, sales, production issues, consumer claims, product defects, recalls, and other product related matters. The Synca™ APP enables direct contact between the consumers and manufacturers, allowing consumers to have an inside scoop about new merchandise while acting as brand ambassadors in sharing their personal experiences with certain products with people to whom they are connected in the virtual world, such as social media and networking sites. In this manner, the application enables users to promote OEM products by sharing their personal experiences with the products, and allows for instant brand interaction with consumers. A functional diagram which highlights the multiple interrelations of all the players associated with the synchronization of information is provided in FIG. 6.

An embodiment of the mobile application according to this invention (the Synca™ APP) enables OEM manufacturers to capitalize on the marketing capabilities of social media, where they can connect to their existing and potential consumer base, receive instant feedback, instant interaction about a particular product, such what consumers like and dislike about the product, while simultaneously allowing consumers a unique opportunity to directly interact with the OEM manufacturer and the product brand. For instance, the Synca™ APP can be used by manufacturers for promotional advertising and marketing purposes. As way of example, a manufacturer can introduce programs such as scavenger hunts, where consumers who scan the largest number of items using the Synca™ APP would qualify for a raffle prize or some other promotional item. In another program, after a consumer purchases an OEM product which is part of a particular promotion, and shares product information using the Synca™ APP, he or she will receive a coupon for a future purchase. Other marketing and advertising programs may be similarly rolled out using one or more embodiments of the mobile application according to this invention (the Synca™ APP). The consumer can also invite people from their network to the brand and forward them promotional and or events taking place via mobile, either via social media, text, or email.

Using another embodiment of the invention, consumers can interact directly with the OEM manufacturer, gaining quick access to relevant product information. In yet another embodiment of the invention, they can also interact with other consumers with similar tastes, styles, and interests, thereby sharing information, and benefiting from others' experiences with and reviews of a particular product they may be interested in acquiring. By way of example, as soon as a customer posts comments on a social media or networking page about his or her experience with a particular OEM product, people connected to that customer can see the information on the news feed or other updates provided by the social media or networking site. When consumers upload images of themselves using the product, or tag images available from the manufacturer's library on the Internet, others connected to those consumers can get access to the information via the social media and networking websites. Further, when a celebrity uses a product, scans it using the Synca™ APP, and posts images and comments regarding the product on the social media or networking site, such as Facebook or Google+, all those connected to or following the celebrity can access the information, thereby providing additional marketing and advertising opportunities to OEM manufacturers. An additional embodiment allows an embodied synchronization app to enable user's the option to link and sync to others with similar products, taste and or habits.

In a further embodiment of the Synca™ APP, servers need not be used for any of the information and data exchange. Rather, all databases, interactions, and web traffic can be handled using online platforms. In yet another embodiment of the Synca™ APP, the manufacturer's or administrator's database may be available in a cloud instead of on a desktop computer and server.

It will be apparent to those skilled in the art that various modification and variations can be made in the method and system of the present invention without departing from the spirit or scope of the invention. Thus, it is intended that the present invention cover modifications and variations that come within the scope of the appended claims and their equivalents.

Although the invention has been described with reference to the above example, it will be understood that modifications and variations are encompassed within the spirit and scope of the invention. Accordingly, the invention is limited only by the following claims.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Review of various embodied features and capabilities of a synchronized application (herein “SYNCA”):

Embodied Synchronized applications allow the user to determine an authenticity of a product via mobile technology, utilizing either an Universal Product locator, Unique ID, barcode, NFC, RFID, and/or an image of the product or utilizing other communication or synchronization technology (which is compared to a database), along with other communication/synchronization technology.

Embodied Synchronized applications allow the manufacturer to know when a UPL is scanned at a retail location, where they can get real time data on the movement/sale of a product. The collection of data with every scan and performing data analytics and aggregating the data may be used to provide qualitative and quantitative data assessment information to retailers and manufacturers.

Embodied Synchronized applications allow the user to register the product via mobile after purchase.

Embodied Synchronized applications allow the user to scan a receipt or other documents needed, in order to send in for registration and or warranty or organize the user's purchase.

Once a user has a registration, it will be locked and only visible to the owner & law enforcement if lost or stolen.

Embodied Synchronized applications allow for the transfer of registration via mobile to a new party or owner.

When a product is scanned an embodied synchronized application allows the manufacturer to receive a log and notification of all products scanned with the location and user (optionally anonymized.

Embodied Synchronized applications allow the manufacturer to know if a user or customer is near their retail location, so they can send notifications or coupons to entice them to shop.

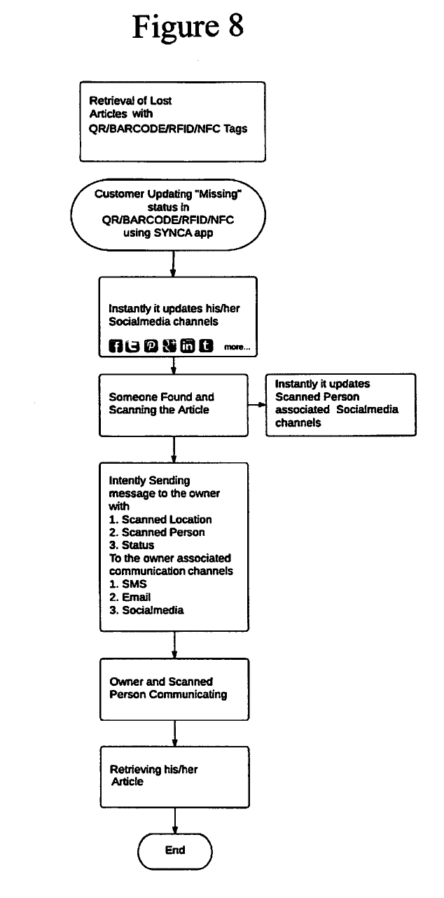

As shown in FIG. 8 Embodied Synchronized applications assist when a product is lost or stolen to get scanned by a finder the owner gets notified of the scan with location and user/finder along with law enforcement if applicable.

Embodied Synchronized applications allow a user to scan a code or product and enable the user to purchase that exact product instantly and other products via mobile.

Embodied Synchronized applications allow a user to scan a code or product and enable the user to save the products information and or image for later use or shopping.

Embodied Synchronized applications allow people to share their purchases and experiences on social media and also the application administrator's platform, where people share their thoughts, images and experiences about a product. This platform connects people who have a common interest in the same products, thus allowing the user to connect with people who may have the same interest.

Embodied Synchronized applications may contain an admin portal for the App, wherein manufacturers can update products and or codes, and run analytics on their mobile device or PC. This portal is accessed via mobile or web.

Additionally, embodied synchronized applications may provide a platform for Real time Analytics which can be run on mobile device or web which include what products are being sold or not sold, registered, on retail floor, where they are being scanned, how many are being scanned, who is buying them, who is scanning them. Real time Analytics can also determine the specific consumers buying habits and preferences. Embodied Synchronized applications may provide analytics based a consumers size, color preference, average dollar amount spending, where they are shopping, what they tend to buy, and how many people are in their network. This allows manufacturers/brands to send them target specific information.

Embodied Synchronized applications enable users to post on social media, either with comments and picture of the specific product already in Synca's or manufacturer's database or with their own picture they have uploaded via their device.

Embodied Synchronized applications enable customers and users to receive special notifications, recalls, coupons, points and messages that can be passed to their friends or in their networks.

Embodied Synchronized applications enable manufacturers to send a message to the customer after purchase to review their experience on the product. This message can be posted on social media upon the customer's approval.

Embodied Synchronized applications enable customers with same products to connect, upon approval of the party, which is being inquired, to get advise, or experiences with that specific product.

Embodied Synchronized applications enable customers to organize and manage their receipts, registrations, and purchases either via a Synca app or via a third party app such as passport. These receipts can be scanned or accepted via email or text notifications.

Further embodied applications include a consumer product synching method including a consumer; wherein the consumer has a personal mobile device; and wherein the mobile device includes synchronization software; wherein the synchronization software performs any two, three, four, five, six, seven, or more of the above embodied features, including but not limited to:

a method for a user to register a scanned product with a third party host and the manufacturer;
a method for a user to determine the location of a lost consumer product;
a method for a user to determine the authenticity of consumer product;
a method for a user to upload images of a consumer product;
a method for synching connections between users of a consumer product;
a method for a third party to collect and aggregate data based on scans of the consumer product; and
a method for a consumer or a third party to run data analytics based on scans; wherein the analytics can be run on either a mobile or PC format.

### Synchronization of Stolen Item Information

### Law Enforcement:

An embodied SYNCA APP maintains a way for law enforcement to utilize the app in addition to the consumer and manufacturer side.

If products are stolen or missing from manufacture, they may not want to designate them as ““stolen, or illicit” to the consumer scan, but we will designate them as “fake” or “compromised.” That way the consumer doesn't buy them and aid in the stolen merchandise black market. They will have the option to report the code and where it was scanned.

If products are missing or stolen, then the codes will be locked into a “stolen” or “compromised” position. So this way when it's scanned it will send a message to the manufacturer that the code was scanned at a particular location and the message “stolen or “compromised” will come up in the message instead of “fake” Only the message fake will come up to the consumer. A message can also be sent to law enforcement of the scan if the owner or the merchandise has reported it and is logged with law enforcement.

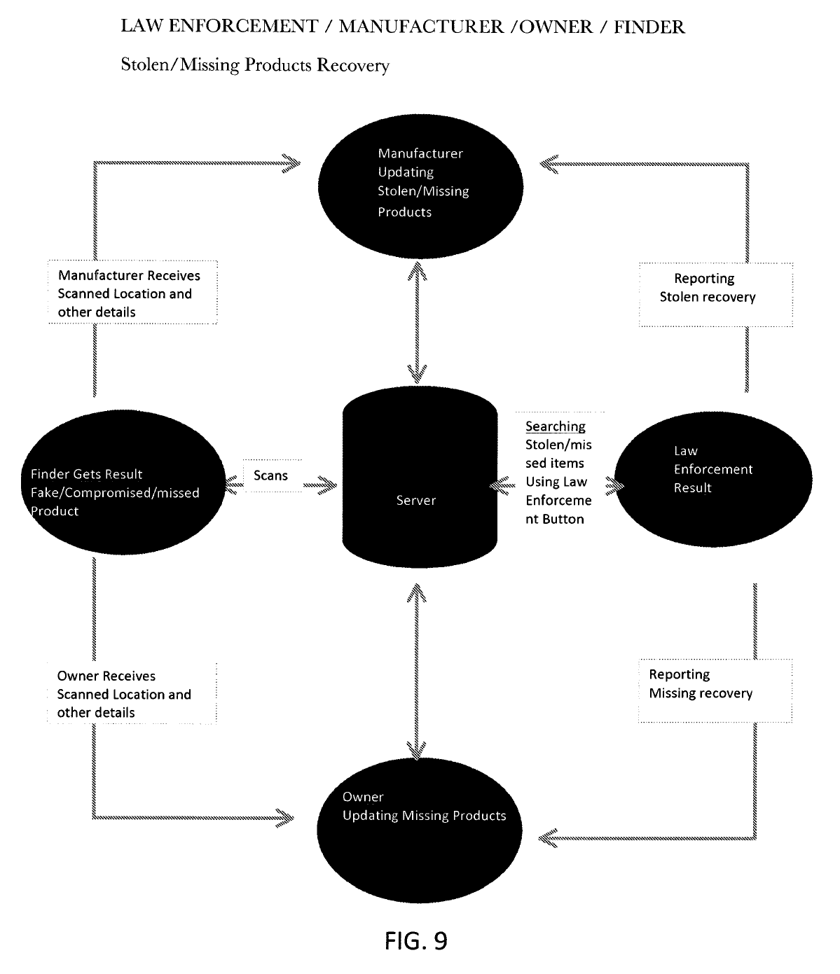

Law enforcement will have either a separate button only functioning for them, or a code they punch in to take them to a database where the stolen codes are stored. The scan will compare the codes and advise them if the product is stolen or compromised. They will be able to see if a police report or any other details is attached to these codes from the manufacturer to better identify the problem. When law enforcement scans, an option to whether or not the location will be sent to the manufacturer or the scan of the code is presented. A flow chart with showing the decision making interrelations is demonstrated in FIG. 9.

### Example 3

Synchronization Mobile Application is downloaded onto a mobile device.

The mobile device is used to scan a product of interest.

Information is synchronized with OEM site to confirm status of goods.

If product is authenticated a new set of optional after purchase decisions on the APP emerge.

Scan via barcode, QR, NFC, RFID via smartphone.

Message provided on phone whether product is real or fake.

After scan a message is simultaneously sent to manufacturer that the code and product has been scanned at a particular location. This feature is used by the app to determine if the product belongs to the retailer selling the goods, which eliminates copies of barcodes on counterfeit products. It also may eliminate the need for transshipping by retailers.

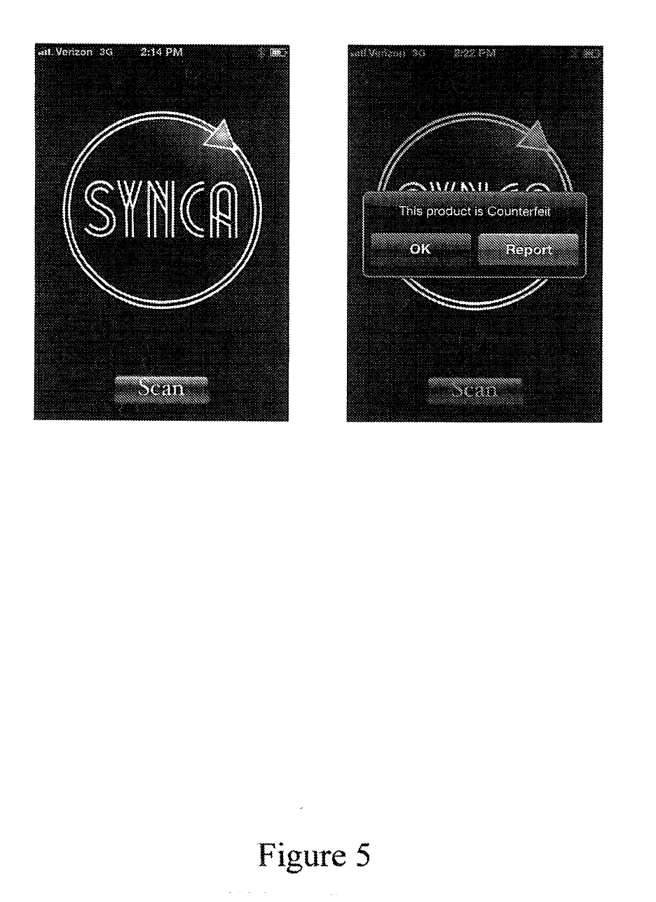

If product is counterfeit, then a message appears on the phone to the customer saying “this product is counterfeit, or fake.” An embodied depiction using the synchronized application is demonstrated in FIG. 5.

If the product is real the app will take the user into another screen advising the product is real or genuine (authentic), and will give the user the name of the product and style. There will be buttons you can choose from to continue your experience. A security feature contemplated may demand that in order for the user to continue they should be authorized to scan a receipt or put in their info.

The message displayed if product is legitimate could be “authentic” or “genuine” or other language pertaining to original or non-counterfeit goods.

If not real then the message displayed may be “fake” or “counterfeit” or other language pertaining to non-original or counterfeit goods.

If the product is stolen the “Stolen” or “Compromised” message is sent.

An additional gateway or doorway for law enforcement to check on goods in addition to the just normal app. One may not want normal consumers to see any Stolen goods on the app, only Law Enforcement.

For example if goods are stolen from a delivery, or inside the company. The company will take those set of codes and lock them into a “stolen or compromised” designation, so when it is scanned by law enforcement it will come “stolen or compromised” but on the consumer end it will come up “fake” so people are not tempted to buy “stolen” goods.

Example of an embodied Mobile Synchronization Application

An embodied synchronization application is created to identify an OEM (original equipment manufacturer) product and a counterfeit product for consumers and manufacturers, while communicating on all Social Media platforms.

The embodied application aims to identify whether a product is genuine or imitation by BARCODE/QR/RFID/NFC comparison. The BARCODE/QR/RFID/NFC of the available products needs to be scanned and add relevant information such as where it made, which factory, which lot or cut #, what material lot was used from where, dye, bottles, fabric, metals, etc., where retailer has the product at, which operator or person worked on the product, etc., and selected information is saved by the manufacturer. When a consumer scans the BARCODE/QR/RFID/NFC of a product, a synchronization application (SYNCA) will take care of comparison with the manufacturer's scanned and added details. If the comparison matches then it will confirm it as a Genuine Product, otherwise will consider as an imitation product.

Buttons may be as follows: 1. Register 2. Re-scan 3. Buy 4. Product details 5. Comment 6. Store details 7. Coupon 8. Location 9. Facebook 10. Twitter 11. Pinterest 12. Promotions/coupons 13. Endorse 14. Report product 15. Website 16. Help 17. Link 18. Sync.

The user can post on social media about their product. They can post on the manufacturer's page as well as their own and share comments they may have.

The user can tag friends, and may receive a promotion or gift card that can be forwarded to their friends by sharing the coupons via the synchronization application. They can also invite friends to experience the brand, either through special promotions or events. These coupons, gift cards, promos, can be stored in passbook for later use.

The embodied Synca applications have a platform where all products scanned and commented will go to a site that is run by the application host. This platform is a space for all scanned products or products which have an image stored in the backend database to be instantly put on the application host's social media site. This site allows people to talk about their experiences and thoughts on companies after their purchases. It is sort of like “Angie's List” and Pinterest combined. It will “sync’ people who are talking about the same products. It will allow customers to post things from their other social media sights, so people can come to the application host site, to determine what is a good product and what may not be.

After a purchase the customer can register the product, in case it ever is lost or for any insurance purposes. A valid registration is provided and all is done via the Smartphone. This registration can be transferred to a new owner if applicable.

The user may have the option to buy the product instantly also. i.e., if you are in a coffee shop and admire someone's jacket. Instead of asking where they got the jacket, just simply scan the barcode, RFID, or NFC on the jacket, which will give information directing you to a buy button on the app. The user can even send a gift card to a colleague through the app if they happen to know he or she would like a particular product. Another embodiment enables the user to communicate and also send the manufacturer messages after scanning.

The customer also has the option to report the product to the manufacturer if the message appears “counterfeit”. They can add images and location be sent instantly when the code is scanned to the manufacturer.

While on comparison the manufacturer will receive a message which contains the scanned location of consumer and the consumer's information which collected on registration.

Once the comparison made by a consumer, it allows him/her to purchase the product online. Before purchase, the consumer can send the product link to multiple friends, option to the consumer to send a gift to a friend and post scanned information in all social media which configured on the device, with pie in database.

When a consumer scanned a product it automatically posts on SYNCA with an option message that will go on SYNCA's page or site by choosing an Icon of a heart or a check sign symbol, which endorses or says, “I vouch for this product” which let's the consumer know who synced, where and when. It works similar to Instagram with additional feature of texts entered by other consumers. Following are endorsements criteria, SYNCA adopted.

a) Heart=Love this
b) Check sign=vouch for
c) A person on a bicycle=You have to try this

SYNCA's Site page has similarities to popular site Pinterest but it is platform for people to talk about their experiences and loves of products or anything else they want to share with SYNCA and the public. If the consumer is posting on Facebook, it will also post on SYNCA's site. It has the option to share or sync multiple friends to the conversation about the product. The consumer also has the option to send a coupon or promotion to a friend via SYNCA. It Syncs the products together if multiple people are talking and syncing the same product and will let the consumer know this in real time. On this page SYNCA has incorporated with the following Buttons for ease of and communication:

a. Sync
b. Re-sync
c. Share
d. Buy
e. Love
f. Vouch
g. Try
h. Review
i. Tags

After purchasing the product, the customer can register the product and get a valid registration, which can be transferred upon the sale of the product by the owner. The owner locks information can save to passbook etc. I.e. —Rolex, Artwork, Paintings, or any high-ticket items.

The BARCODE/QRIRFID/NFC needs to be generated by the manufacturer or administrator or can be supplied by the owners of the synchronized technology, which will be available to them to maintain until the delivery made to a retailer or to a consumer. Each product BARCODE/QRIRFID/NFC will be unique which signifies either a product or SKU. No product should have the same digits, regardless of style/color/size/composition.

After purchasing the product, the customer can register the product and get a valid registration, which can be transferred upon the sale of the product by the owner. The owner locks information can save to passbook etc. I.e. —Rolex, Artwork, Paintings, or any high-ticket items

### Scanning Methodologies

SYNCA equipped with the following scanning technologies:
a. Any Barcode or 2d Barcode
b. QR
c. RFID
d. NFC
e. Or other communication and synchronization technology

SYNCA APP available in following smart phones:
a. iPhone
b. Android
c. Blackberry
d. Windows

Following describes the working scenario of scanning BARCODE/QR

Open up the application installed in iPhone, Android or Blackberry phone and point camera to Barcode/QR

The camera detects the Barcode/QR.

It can also read NFC tags, which are read by NFC capable phones.

The RFID is scanned separately using the hardware in the phone.

This code is detected and sends information to the database.

The database is searched for the code and sends it back to the phone.

### Modules

### 1. Customer Application

### 2. Manufacturer/Admin Application

### Exemplary—Customer Application

### 1.1 The App Concept

Once the application is installed and logged in on any iPhone, Android or Blackberry type smartphone the phone does not need to re-login each time when the user starts the application.

Suppose a user goes to a store to buy a Nike limited edition shoe. The customer has doubt if the product is authentic or original or not.

The user opens up the SYNCA application installed in the phone.

The option in the application to SCAN is chosen.

The camera in the phone is switched “on” so the customer just has to shoot picture of the BARCODE/QR of article of interest (shoe in example).

The RFID is detected automatically by the application.

The NFC tag is read by the NFC phone using the SYNCA application.

The BARCODE/QR/RFID/NFC that is read is compared to the database.

If the item is found then the message is sent to the customer application that the product is original.

If the item is not found in the database then a message is generated saying imitation product.

After being scanned the application ill upload the image to social media from a database as supplied by manufacturer's catalog or from the consumer's Instagram or camera.

The Consumer can message the manufacturer instantly for questions or comments, after or before the scan.

The application may also display similar products associated with the current products.

A Coupon Button for the providing for sending the coupon may be present.

The user may also use the application to find the details of any product with a Barcode/QR/RFID/NFC that is stored in the database.

Suppose the user sees a net book with a friend then the user can just scan the barcode/

QR/RFID/NFC to get all the details stored in the database.

This will provide the specification, name, category, Facebook and Twitter link depending on the entries in the database.

### The Process

### 1.2 Login

Event—Enter the Username and Password and select “login” button.

Result—Successfully logged in if the login details are correct. Otherwise, it will show up in a pop up with a message “Username or Password Incorrect” and stays on the login screen.

### 1.3 Scanning the Product

Tapping “Scan” option of SYNCA application which activated the mobile camera and pointing to the Barcode/QR/RFID/NFC of the product.

1.4 Genuine Product will list out some of the following information after scanning:

Product name; where manufactured; which factory; which lot or cut #; what material lot was used; from where was it delivered; dye, bottles, fabric metals, etc.; where the retailer of the product is; which operator or person worked on the product, etc.; the manufacturer; displays “The Product is Original” message.

1.5 Imitation Product will list out some of the following information after scanning:

The manufacturer entered details are not available in the database for comparison; the mentioned retailer location is wrong; the product has already been owned by someone; the product is imitation or the product cannot be confirmed as authentic.

1.6 Automatically Sharing Consumer scanned information to manufacturer:

Where product has been scanned (using GPS or Manual entry); Name of the consumer who scanned it; Address; email address; telephone/mobile numbers.

### 1.7 Manually Sharing Product Information:

Sharing scanned product details with friends using SYNCA, Facebook, Twitter, Pinterest, Google+ and all other planned social medias; sending gift to friends; posting information to social media; manually sharing information about products to all friends and non-friends within different apps.

1.8 Virtual Communication possibilities:

Blog; Chat; Comments; Add ratings—Love this, I vouch for, you have to try this, etc.; similar kind of product listing; other products listed by the same manufacturer; sending queries or comments to the manufacturer.

1.9 Product Purchase—allows for online purchase of product.
1.10 Product registration:

Once the product is scanned and bought, the user can take ownership.

The registration may include the following Auto generated details, but the registrant can edit if necessary changes that need to be added or removed:

Company name; Date purchased; purchased from; owner name; address; country; contact phone; contact email; status-new/used; serial number.

1.11 Logout—the user selects a “log-out” button to log out or a time out button will automatically logout a user who has been inactive for a preselected period of time.

### 2. Manufacturer/Admin Application

The admin can ensure that the products they are selling are original by using a Synca application installed on a company smartphone.

The admin logs into the application using the username and password combination.

Once the admin is logged in he/she is able to scan any barcode/QR by the camera in the phone itself.

Clicking on the scan button will start the camera.

Just pointing the camera to the barcode/QR until it is read by the application correctly.

A RFID detector on the phone is activated when the user logs in to the application.

The detector automatically detects any RFID's and the admin enters the details.

The NFC tags can be read by the NFC phones.

Once the item is correctly scanned the data is stored into the database, along with the other necessary product details.

These details are entered by the manufacturer which is stored into the database, and can export the details, based on sales, demographics buying habits, style, color, region, season, scanned and un-scanned products.

### The Process

2.1 Login

Event—Enter the Username and Password and select the “login” button. Result—the user is successfully logged in if the login details are entered correctly. Otherwise, it will show a pop up with a message “Username or Password Incorrect” and stay on the login screen.

2.2 Choosing Product

The available product types are listed on a drop down list. The user selects the product type of interest from the drop down list.

2.3 Scanning the Product of interest.

Tapping “Scan” option of SYNCA application which activated the mobile camera and pointing to the Barcode/QR/RFID/NFC of the product.

The Product of interest will list out some of the following information after scanning:

Product name; where manufactured; which factory; which lot or cut #; what material lot was used; from where was it delivered; dye, bottles, fabric metals, etc.; where the retailer of the product is; which operator or person worked on the product, etc.; the manufacturer; displays “The Product is Original” message.

2.4 Sharing and Adding Coupons or Add-ons:

The manufacturer may use the app to share coupons; share product to social networks; customer query answering area.

2.5 Logout—the user selects a “log-out” button to log out or a time out button will automatically logout a user who has been inactive for a preselected period of time.

An embodied synchronization application is created to identify an OEM (original equipment manufacturer) product and a counterfeit product for consumers and manufacturers, while communicating on all Social Media platforms.

### 3. Social Networking Features

### 3.1 Facebook

If an existing user, login with Facebook username and password. If a new user, sign up for Facebook then type the comments, attach the image from the library, or click on the button Publish Stream. Once the success message “Posted Successfully” in Facebook shows the information can get posted to Facebook and other social medias.

### 3.2 Twitter

If an existing user, login with Twitter username and password. If a new user, sign up for Twitter then type the comments, click on the “Publish” button. Once the success message “Posted Successfully” in Twitter shows the information can get posted to the Twitter.

### 4. Graphical Representations

As represented in FIG. 7 which depicts exemplary graphing of embodied analytic reports via Sales and Scanning Analytics based on male/Female/Age using the Synca™ APP on a mobile device, once the product has been scanned and the product registration is done all the necessary details are stored into the database. Since data such as location, date of purchase, shop name etc., are stored, the corresponding data can be used for generating graphs. This in turn can be used for effective marketing.

The following are non-limiting examples of the types of graphs that can be generated:

Type 1—Graph with the product sales in a product with date (Daily, monthly yearly).

Type 2—Graph showing the product sales in a product with a location graph.

Type 3—Graph showing the product sales in a location with date.

Type 4—Graph showing the product sales in the store with date.

Type 5—Graph showing the product sales in a store with a product graph.

Although the invention has been described with reference to the above example, it will be understood that modification and variation are encompassed within the spirit and scope of the invention. Accordingly, the invention is limited only by the following claims:

What is claimed is:

1. A mobile device software application developed for a mobile device or smart phone that enables detection and verification of genuine OEM products, and further allows communication about such products on the manufacturer's social networking websites, official manufacturer websites, as well as shopping carts, and reviews web pages on the manufacturer's or other authorized retailer's websites on the Internet.

2. A method for determining the authenticity of a consumer good comprising:
the mobile device software application of claim 1;
a mobile smartphone device with scanning technology; and
a consumer good with a specific identification tag.

3. A method for determining the location of a consumer good comprising:
the mobile device software application of claim 1;
a mobile smartphone device with scanning technology; and
a consumer good with a specific identification tag.

4. A method for collecting and aggregating data based on the scanning of a consumer good comprising:
the mobile device software application of claim 1;
a mobile smartphone device with scanning technology; and
a consumer good with a specific identification tag.

5. A consumer product synching method comprising:
a consumer; wherein the consumer has a personal mobile device; and wherein the mobile device includes synchronization software;
wherein the synchronization software performs any two or more of the following features;
a method for a user to register a scanned product with a third party host and the manufacturer;
a method for a user to determine the location of a lost consumer product;
a method for a user to determine the authenticity of consumer product;
a method for a user to upload images of a consumer product;
a method for synching connections between users of a consumer product;
a method for a third party to collect and aggregate data based on scans of the consumer product; and
a method for a consumer or a third party to run data analytics based on scans; wherein the analytics can be run on either a mobile or PC format.
